(19) United States
(12) Patent Application Publication
(10) Pub. No.: US 2009/0319453 A1
(43) Pub. Date: Dec. 24, 2009

(54) Sampling Strategy Using Genetic Algorithms in Engineering Design Optimization

(75) Inventor: Tushar Goel, Livermore, CA (US)

Correspondence Address: ROGER H. CHU, 19499 ERIC DRIVE, SARATOGA, CA, 95070, US

(73) Assignee: Livermore Software Technology Corporation, Livermore, CA (US)

(21) Appl. No.: 12/145,339

(22) Filed: Jun. 24, 2008

(51) Int. Cl. G06N 3/12

(52) U.S. Cl. 706/13

(57) ABSTRACT

A sampling strategy using genetic algorithms (GA) in engineering design optimization is disclosed. A product is to design and optimize with a set of design variables, objectives and constraints. A suitable number of design of experiments (DOE) samples is then identified such that each point represents a particular or unique combination of design variables. The sample selection strategy is based on genetic algorithms. Computer-aided engineering (CAE) analysis or analyses (e.g., finite element analysis, finite difference analysis, mesh-free analysis, etc.) is/are performed for each of the samples during the GA based sample selection procedure. A meta-model is created to approximate the CAE analysis results at all of the DOE samples. Once the meta-model is satisfactory (e.g., accuracy within a tolerance), an optimized “best” design can be found by using the meta-model as function evaluator for the optimization method. Finally, a CAE analysis is performed to verify the optimized “best” design.

### FIELD OF THE INVENTION

The present invention generally relates to engineering design optimization, more particularly to sampling strategy using genetic algorithms (GA) in engineering design optimization.

### BACKGROUND OF THE INVENTION

Today, computer aided engineering (CAE) has been used for supporting engineers in tasks such as analysis, simulation, design, manufacture, etc. In a conventional engineering design procedure, CAE analysis (e.g., finite element analysis (FEA), finite difference analysis, meshless analysis, computational fluid dynamics (CFD) analysis, modal analysis for reducing noise-vibration-harshness, etc.) has been employed to evaluate responses (e.g., stresses, displacements, etc.). Using automobile design as an example, a particular version or design of a car is analyzed using FEA to obtain the responses due to certain loading conditions. Engineers will then try to improve the car design by modifying certain parameters or design variables (e.g., thickness of the steel shell, locations of the frames, etc.) based on specific objectives and constraints. Another FEA is conducted to reflect these changes until a “best” design has been achieved. However, this approach generally depends on knowledge of the engineers or based on a trial-or-error method.

Furthermore, as often in any engineering problems or projects, these design variables, objectives and constraints are generally in conflict and interact with each other nonlinearly. Thus, it is not very clear how to modify them to achieve the “best” design or trade-off. This situation becomes even more complex in a multi-discipline optimization that requires several different CAE analyses (e.g., FEA, CFD and NVH) to meet a set of conflicting objectives. To solve this problem, a systematic approach to identify the “best” design, referred to as design optimization, is used.

This approach would work if the product is relatively simple. When the product becomes more complex, for example, an automobile, a single crashworthiness analysis may require many hours if not days of computation time even with a state-of-the-art multi-processor computer system. Long computing time and the associated costs render this approach unfeasible. To overcome this shortcoming, computationally inexpensive meta-models are developed and used for the design optimization.

Meta-models are mathematical equations that can be calibrated to approximate responses of relative few samples of design points, each representing a specific design variation. Only the chosen design points are analyzed using CAE analysis, hence the computation time and costs become manageable. As a result, the predictability accuracy of the meta-models is depended directly upon the selected samples. However, to select a set of samples that is properly representing the design space (i.e., a multi-dimensional space with each dimension for one design variable) is not easy to accomplish. The problem is further aggravated when there are more than one design objectives. Many prior art approaches to select samples are not satisfactory, some require large number of samples, some fail to focus region of interest, some have high potential of getting misled to sub-optimal regions. Therefore, it would be desirable to have improved methods and systems for effectively selecting samples in a multi-dimensional design space to conduct an engineering design optimization.

### BRIEF SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

The present invention discloses a sampling strategy using genetic algorithms in engineering design optimization. According to one aspect of the present invention, a product is to design and optimize with a set of design variables, objectives and constraints. A suitable number of design of experiments (DOE) samples is then identified such that each point represents a particular or unique combination of design variables. The sample selection strategy is based on genetic algorithms. Computer-aided engineering (CAE) analysis or analyses (e.g., finite element analysis, finite difference analysis, meshless analysis, etc.) is/are performed for each of the samples during the GA based sample selection procedure. A meta-model is created to approximate the CAE analysis results at all of the DOE samples. Once the meta-model is satisfactory (e.g., accuracy within a tolerance), an optimized “best” design can be found by using the meta-model as function evaluator for the optimization method. Finally, a CAE analysis is performed to verify the optimized “best” design.

According to another aspect, the genetic algorithms based sample selection procedure comprise at least the following steps: identifying design problem (i.e., objectives, constraints and variables); pre-deciding total number of experiments; setting the GA parameters (e.g., population size i.e., number of individuals or samples, number of generations to create samples, genetic operators e.g., selection, crossover, mutation operators etc., probability of crossover, probability of mutation, selection criterion, etc.); performing a GA simulation to create DOE samples, from which a meta-model is created.

According to yet another aspect, the GA simulation includes selecting a set of individuals as an initial parent population either randomly or based on other strategies (e.g., space filling design); evaluating the initial population (e.g., perform FEA on each individual); assigning fitness or rank to each individual in the initial population (e.g., based on the FEA results and/or non-domination criterion for all design objectives); selecting individuals from the parent population based on the fitness or rank (e.g., high rank or fitness individuals are preferred) to form a mating pool; creating a set of children from individuals in the mating pool using crossover and/or mutation procedures; evaluating the children (i.e., FEA analysis); optionally applying elitism to a combined group of parents/children (e.g., selecting high rank or fitness individuals from the group) to form a new population (i.e. another parent population); repeating the parent selection and child creation process described herein until the GA simulation has reached predetermined stopping criterion (e.g., maximum number of generations or other criteria). All of the individuals (i.e., all parents and children) during the GA simulation are then used as the selected DOE samples.

According to yet another aspect, the rank is assigned using a non-domination selection criterion for all of the design variables. When two or more individuals have equal rank, the one located in a less crowded design space is selected based on a crowded distance of each individual. In a single objective optimization, fitness score based on the engineering analysis results can be used instead of rank. Those individual with high fitness score are preferred to be selected because they are closer to achieve the design objective.

According to yet another embodiment, crossover and mutation procedures are conducted based on predefined probability. Different values of the design variables in each individual are represented by a set of binary or real numbers.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1A is perspective view of a tubular member of a product that may be designed by design optimization process in accordance with an embodiment of the present invention;

FIG. 1B is an X-Y diagram showing a multiple objective design optimization with two design objectives, when both objectives are minimized;

FIG. 2A is a diagram illustrating a number of design of experiments (DOE) points based on a single design variable (X₁);

FIG. 2B is a diagram illustrating a number of design of experiments (DOE) points or samples based on two design variables (X₁ and X₂);

FIG. 3A is a diagram showing exemplary sequence of creation of DOE samples using genetic algorithms in accordance with one embodiment of the present invention;

FIGS. 3B and 3C are diagrams showing exemplary parent selection and children creation procedure in accordance with one embodiment of the present invention;

FIGS. 4A-4B are diagrams showing two exemplary procedures of performing crossover of a pair of parents, according to an embodiment of the present invention;

FIGS. 4C-4D are diagrams showing two exemplary procedures of performing mutation of an individual sample, according to an embodiment of the present invention;

FIG. 5A and FIG. 5B show exemplary crossover procedure in binary and real number representations, respectively;

FIG. 5C and FIG. 5D show exemplary mutation procedure in binary and real number representations, respectively;

FIGS. 6A-6B collectively is a flowchart illustrating an exemplary process of performing engineering design optimization using genetic algorithm based sampling, according to an embodiment of the present invention; and

FIG. 7 is a function diagram showing salient components of a computing device, in which an embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

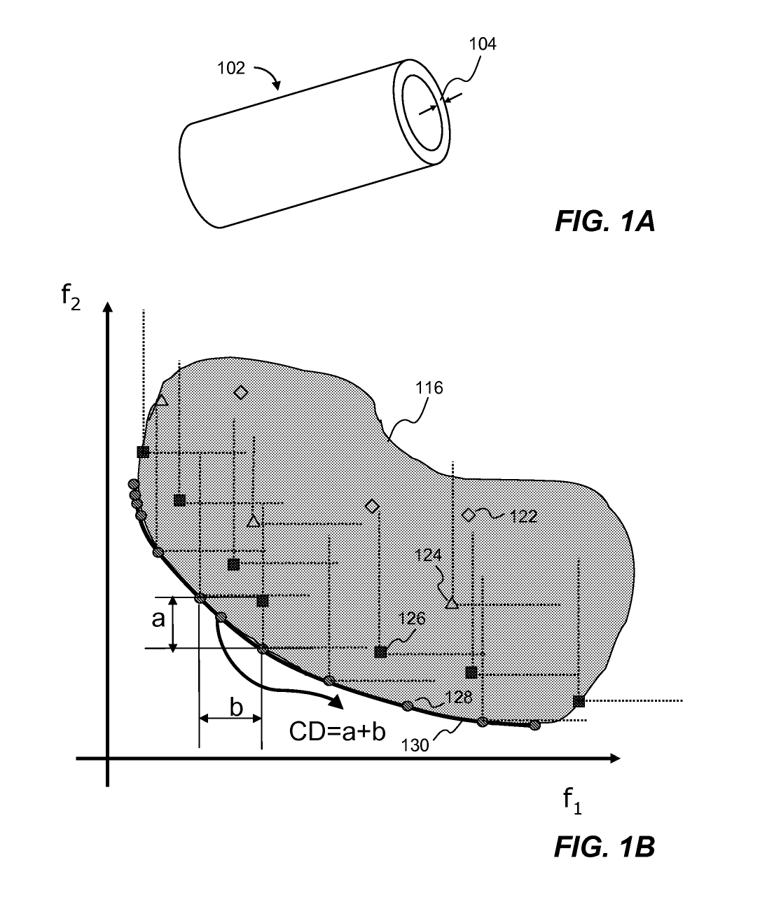

Embodiments of the present invention are discussed herein with reference to FIGS. 1A-7. However, those skilled in the art will readily appreciate that the detailed description given herein with respect to these figures is for explanatory purposes as the invention extends beyond these limited embodiments.

Referring first of FIG. 1A, a tubular structural member 102 is optimized in an engineering optimization with design objective of minimizing the weight therefore minimizing the cost for a given material (e.g., regular strength steel) under certain design loading condition. It is evident that thinner thickness 104 would lead to a less weight structure. However, at certain point, the structural would become too weak to stand a design load (e.g., structural failure due to material yielding and/or buckling). Hence, the engineering optimization of this tubular structure requires another design objective of maximizing the strength, which leads to a safer structure.

Based on two conflicting design objectives, FIG. 1B is an X-Y diagram showing a results of an exemplary design optimization. Two axes represent two different objectives in form of functions f₁ and f₂. In a multi-objective optimization, there is no one optimized solution instead there is a set of solutions that reflects tradeoffs among objectives. In order to differentiate each solution, a concept called non-domination criterion is used for comparing solutions.

The non-domination criterion is defined as follows: a solution x(1) dominates another solution x(2), if either of the following three conditions is true.

1. x(1) is feasible and x(2) is infeasible.
2. Both x(1) and x(2) are infeasible but x(2) is more infeasible compared to x(1).
3. Wen both x(1) and x(2) are feasible, the following two conditions must be satisfied:

a. x(1) is worse than x(2) in all objectives; and

b. x(1) is strictly better than x(2) in at least one objective.

FIG. 1B shows a two-objective unconstrained minimization example. Each dot represents a solution in the design space that is shown in shaded area 116. For each diamond 122, there is at least one triangle 124 that is better than the diamond 122 in at least one objective without being inferior in other objective. So all individual samples in diamond 122 are dominated by the triangles 124. Similarly, all triangles 124 are dominated by squares 126 and squares are dominated by circles 128. No solution represented by triangles 124 can be said better than any other solution represented by triangles 124, thus they are non-dominated with respect to each other. All individuals represented by circles 128 are non-dominated with respect to any other individual hence having a best or highest rank (e.g., rank of one). If all points represented by circles are removed from FIG. 1B, then the individuals represented by squares 126 become non-dominated with respect to all others. Therefore, squares 128 are assigned next best rank (e.g., rank of two), and so on.

In the example shown in FIG. 1B, circles 128 represent a set of Pareto optimal solution and the line 130 connecting all circles 128 is called the Pareto optimal front. It is noted that there would generally be more than one individual or solution having the same rank. In order to further differentiate same rank individuals or solutions, one rule is to select the one that is located in a less crowded region of the design space. This can be done by calculating crowding distance (CD) of each individual. Individual with greater CD is located in a less crowded region. Shown in FIG. 1B, CD is calculated with the following formula: CD=a+b, where ‘a’ and ‘b’ is distance between two adjacent neighbors of the individual in respective design objectives.

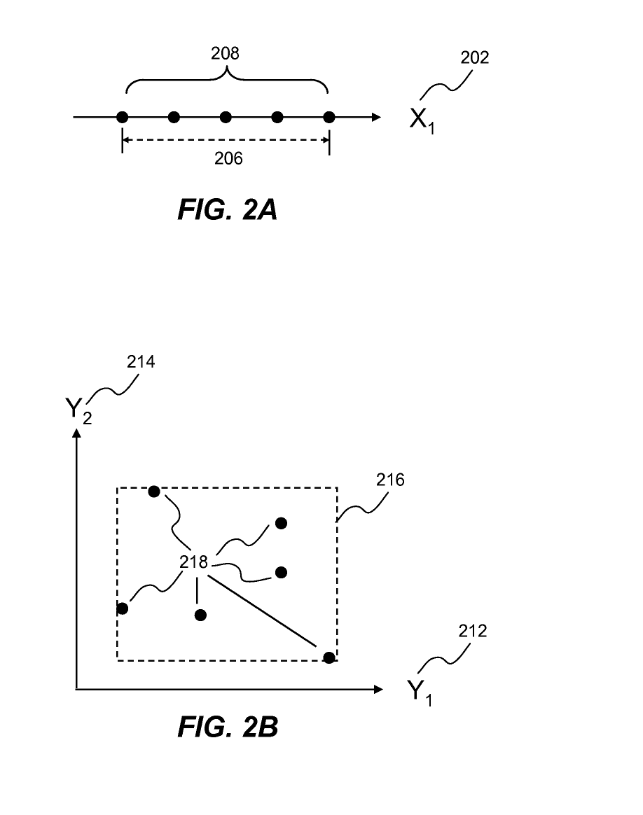

FIG. 2A is a diagram showing a set of five DOE samples 208 plotted against design variable X₁ 202. A design space 206 shown as dotted line defines a range in which the product is to be designed and optimized. Using tubular member of FIG. 1A as an example, the design variable 202 may comprise thickness of the tubular wall. For example, the design space 206 may include a range from ⅛ inch to half an inch. FIG. 2B shows DOE samples 218 scattered in a two-dimensional design space 216 defined by two design variables Y₁ 212 and Y₂ 214. In the tubular member example, there may be two design variables: thickness of the tube wall and diameter of the tube. In reality, there are many design variables used in an engineering optimization. For example, a design space is a three-dimensional (not shown) for three design variables and a higher order multi-dimensional hyper-space (not possible to show in a two-dimensional view on paper) for higher numbers of design variable.

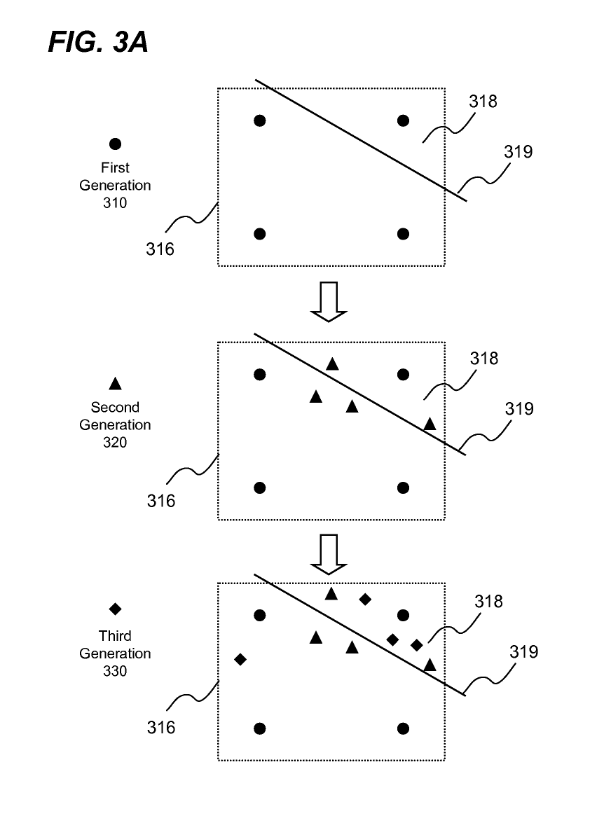

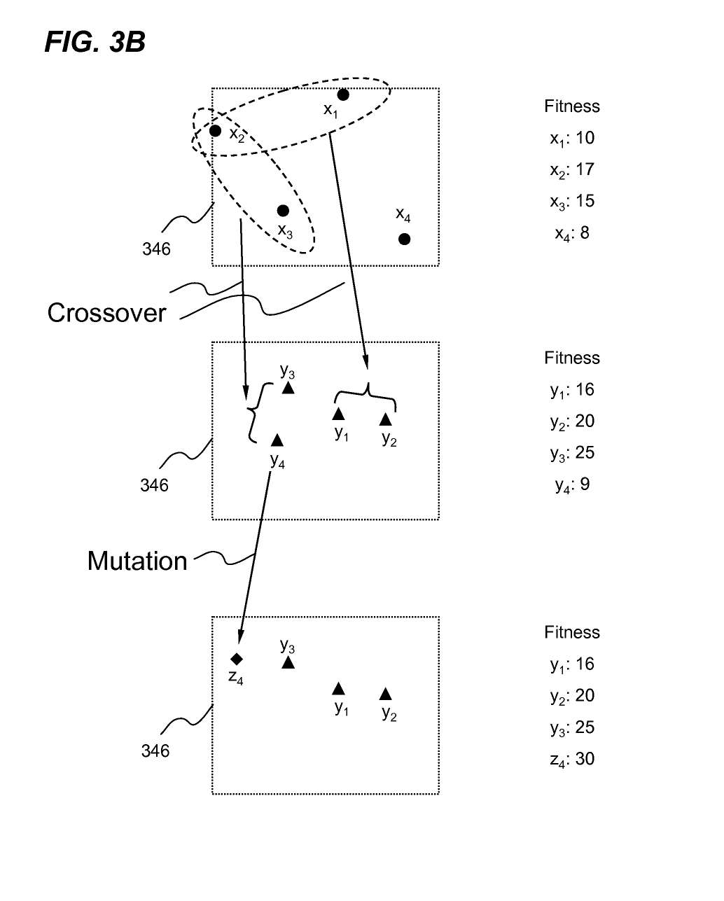

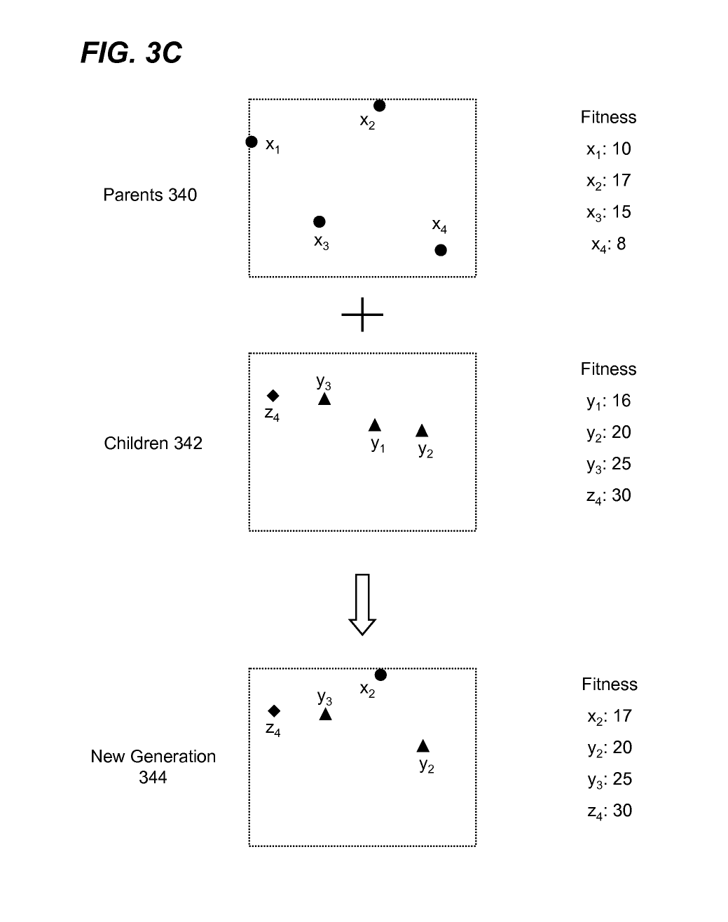

For illustration simplicity, all of the examples shown in this disclosure are in an exemplary two-dimensional design space. In reality, the engineering optimization is conducted in a multi-dimensional hyper-space. FIG. 3A shows an exemplary sequence of creating DOE samples using genetic algorithms (GA), in accordance with one embodiment of the present invention. In this example, the total number of DOE samples is twelve (12), which is created in a two-dimensional design space 316 with three generations or iterations of GA simulation. Each generation contains four (4) individual samples. A local optimal region 318 is bounded by a constraint line 319 and boundary of the design space 316. Initially, a first generation of four individual samples is selected. The initialization can be done randomly or based on some predefined rules or formula. In FIG. 3A, four first generation individual samples (shown in circles 310) are located in four corners of the design space 316. Only one sample is located within the optimal region 318.

A second generation of four samples is shown in triangles 320. It is evident that all four second generation samples are located much closer to the constraint line 319 with two in the optimal region 318. The second generation samples are created from some or all of the samples in the first generation. FIGS. 3B and 3C show an exemplary procedure of creating new generation. Finally, four more samples (shown in diamonds 330) of the third generation are added to the DOE samples. Three of the four third generation samples are located in the optimal region 318. Similar to the creation of the second generation, the third generation samples are created from some or all of the second generation samples. These twelve DOE samples are used for creating a meta-model that leads to a “best” design of an engineering optimization.

Creation of new population of individuals (i.e., children) starts with a process referred to as selection of preferred individuals from parent population into a mating pool. Generally, each of the selected parents in the mating pool possesses high fitness score or rank. In an engineering design optimization, fitness score can be calculated and/or determined by performing a computer aided engineering (CAE) analysis of each sample in an immediate prior generation to the one being created. In a single objective optimization, fitness score has a direct relationship from the results of the CAE analysis. In a multi-objective optimization, fitness score cannot be determined simply from the CAE analysis results. Instead a rank is assigned to each sample based on a non-domination criterion described in FIG. 1B.

FIG. 3B shows an exemplary process of creating children in accordance with one embodiment of the present invention. In the top chart of FIG. 3B, there is shown four DOE samples (x₁, x₂, x₃ and x₄) in circles within a design space 346. Fitness scores of the DOE samples (x₁, x₂, x₃ and x₄) are 10, 17, 15 and 8 based on CAE analysis results. Three samples (x₁, x₂ and x₃) are selected as parents in the mating pool based on the order of the fitness score in this example. In another embodiment, the selection of parents may be based on a different criterion, such as another random selection but with each sample having different probability of being chosen. For example, sample x₁ may have 10 out of 50 (=10+17+15+8) chances being selected, sample x₂ may have 17 of 50, etc. Although fitness scores are shown here, ranks used for multi-objective optimization may be used instead.

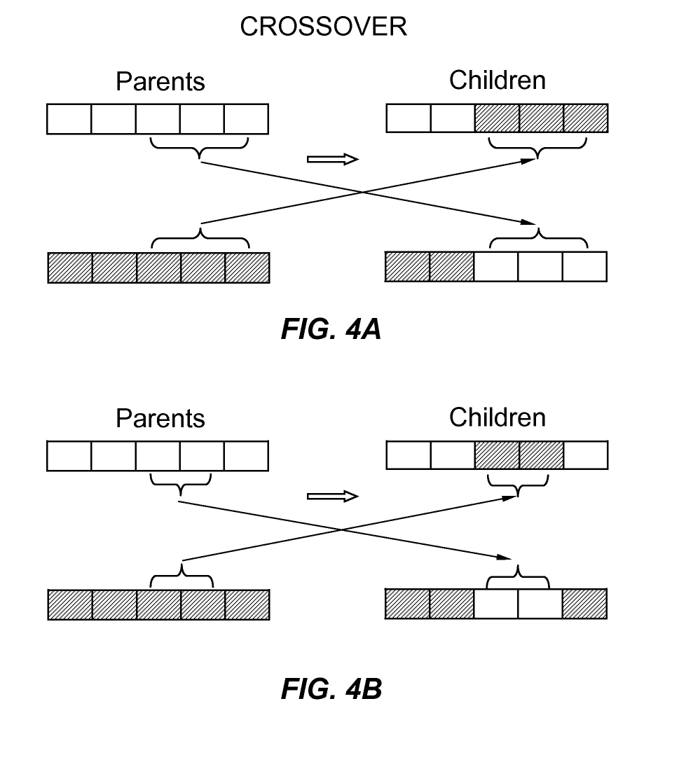

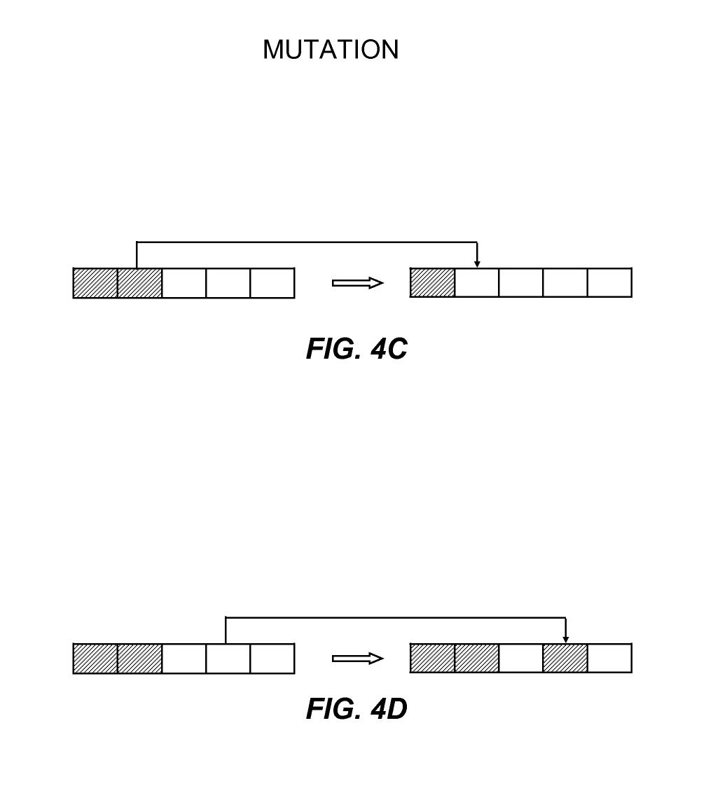

Selected parents are paired up to create children. As shown in the top diagram of FIG. 3B, two pairs (dotted line oval) are formed to create two pairs of children each shown as triangles in the middle diagram. Parents x₁ and x₂ create children y₁ and y₂, and parents x₃ and x₄ create children y₃ and y₄. Each of the parents comprises a number of genes representing values of the unique combination of design variables. Children are created in a crossover process by exchanging one or more genes of the parents as shown in FIGS. 4A and 4B. The genes are represented in binary form such that the genes can be processed easily in a digital computer. When used in engineering optimization, particular values of the design variables are represented a sequence of binary numbers as genes. In another embodiment, a set of real numbers can be used each represents one of the design variables. Crossover is performed by applying a particular combination of relevant variables of the mating parents to each design variable. To further randomize the crossover process, a predefined probability of crossover is used. As a result, some of the parents may not produce any children even though the parents have been selected in the mating pool. In one embodiment, this randomization may be implemented by generating a random number or pseudo random number between 0 and 1 to represent crossover probability for each crossover process. Only the crossover probability is lower than the predefined threshold would trigger the crossover process to produce child/children. In order to maintain the population size constant or substantially constant in each generation, parents that do not produce child/children may become children themselves, according to one embodiment.

In addition to the crossover procedure, another procedure called mutation may be applied to one or more individuals of the child population created by the crossover process. In a mutation procedure, one arbitrary gene in the one or more individuals is flipped as shown in FIGS. 4C and 4D. The bottom diagram in FIG. 3B shows a sample z₄ is created by a mutation of sample y₄. It is noted that the mutation may happen to any one of the individuals, even though the example described herein showing a lowest fitness child sample. Again, the mutation is also subject to a randomization by applying a predefined mutation probability. In general, mutation probability is a relatively low number (e.g., 5%) versus a typical crossover probability (e.g., 90-95%).

As soon as children are created, each child is evaluated (e.g., CAE analysis) to determine either rank or fitness score. In one embodiment, the children would become another parent population to generate next generation. In another embodiment, an optional elitism process is applied to a combined group of all samples of prior generations and newly created children population. One exemplary elitism procedure is shown in FIG. 3C, according to one embodiment of the present invention. In this example, prior generation of parents 340 includes four DOE samples (x₁, x₂, x₃ and x₄). Children population 342 contains four samples (y₁, y₂, y₃ and z₄). A new generation 344 is created by selecting four samples (y₁, x₂, y₃ and z₄) having highest fitness score. After the new population has been formed, another generation of GA can be conducted to evolve the population. Including the elitism process in GA may result into a faster convergence hence achieving sample selection faster.

According to one embodiment, FIG. 4A shows a crossover of a pair of parents to create a pair of children. Each parent contains five (5) genes. Three of the five genes are exchanged to create children. In another embodiment, only two of the five genes are exchanged shown in FIG. 4B. FIGS. 4C and 4D show the mutation procedure occurred at two different locations.

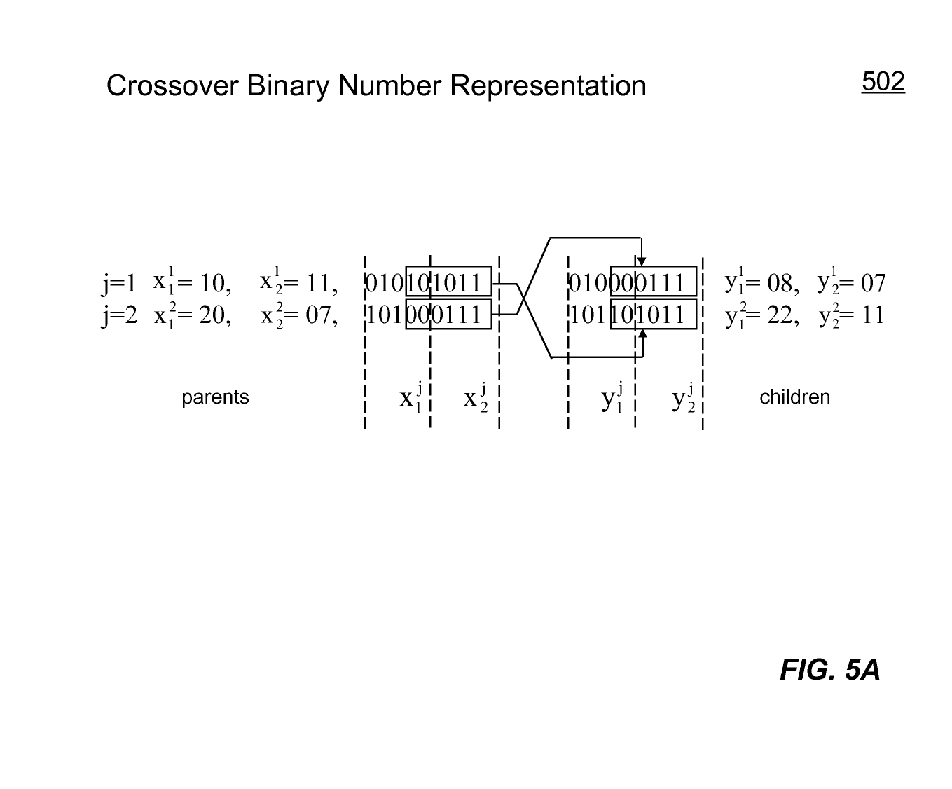

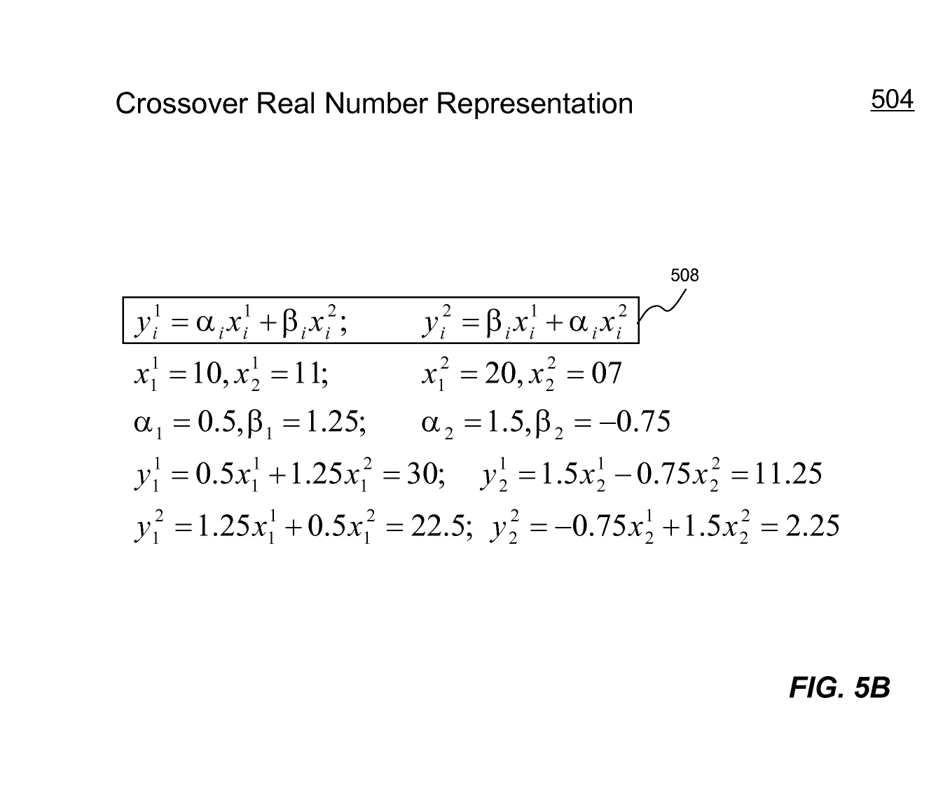

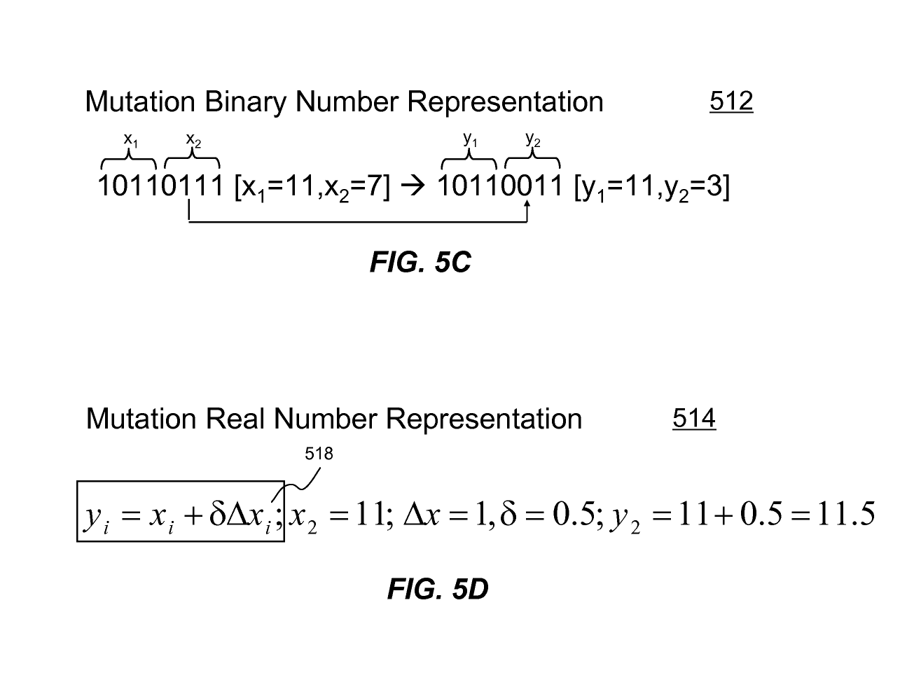

FIG. 5A shows exemplary crossover procedure in binary number representation 502. In this example, ‘parent 1’ comprises two design variables x₁¹ and x₂¹ with values of 10 and 11, while ‘parent 2’ comprises two design variables x₁² and x₂² with values of 20 and 7. ‘parent 1’ is represented by joining two design variables together as ‘010101011’ in binary number, and ‘parent 2’ as ‘101000111’. First five binary digits for the first design variable x₁^{j} and next four binary digits for the second design variable x₂^{j}. ‘child 1’ and ‘child 2’ are created by a crossover procedure of exchanging last six binary digits of ‘parent 1’ and ‘parent 2’, respectively. As a result, ‘child 1’ comprises ‘010000111’ and ‘child 2’ comprises ‘101101011’. Corresponding design variables in ‘child 1’ are y₁¹ and y₂¹ with values of 8 and 7, ‘child 2’ 22 and 11. Crossover is based on one or more binary digits which may include an entire value or a part of design variable.

When the design variables are in real number representation shown in FIG. 5B, crossover may be conducted with formula 508. Using a set of scaling parameter αᵢ and βᵢ, children can be created as demonstrated in FIG. 5B. While a two-parent producing two-children case is shown in the crossover examples described herein, other parent/child ratios may be used in GA. For example, three parents for four children, two parents for one child, etc. The goal in each generation is to produce a predefined number of individuals, which is a constant or near constant through a GA simulation.

FIG. 5C shows exemplary mutation procedure of using binary and number representation 512. Design variables x₁ and x₂ with values 11 and 7 are represented by eight-digit binary number ‘10110111’ with leading four digits for x₁ and trailing four digits for x₂. After one-digit mutation (i.e., digit number 6), the resulting binary number is ‘10110011’, which includes y₁ and y₂ with values 11 and 3, respectively. In real number representation 514 shown in FIG. 5D, the mutation is carried out using equation 518.

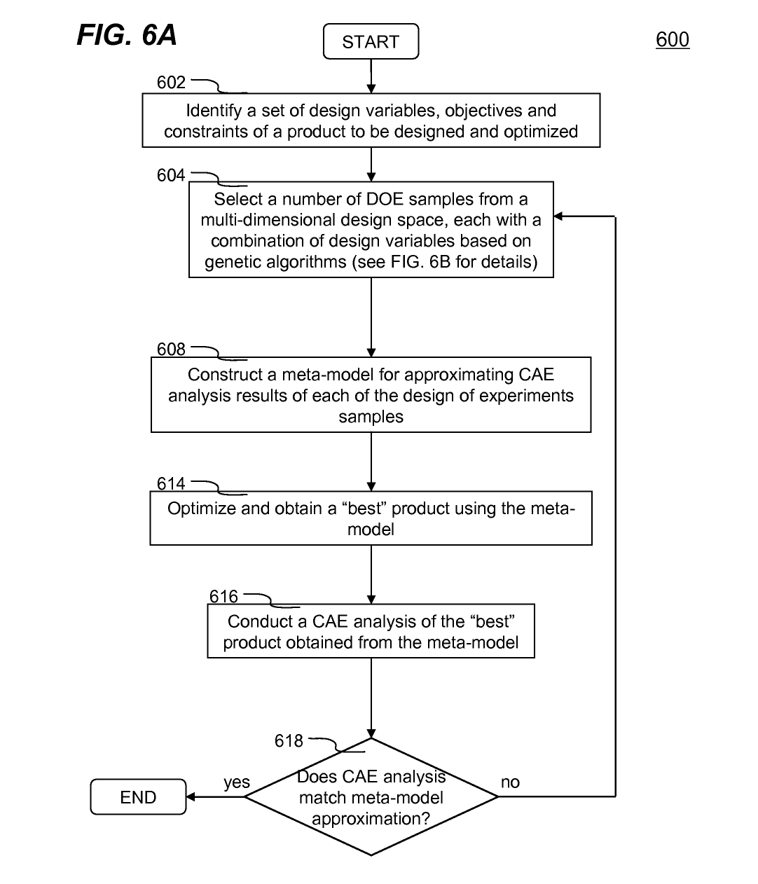

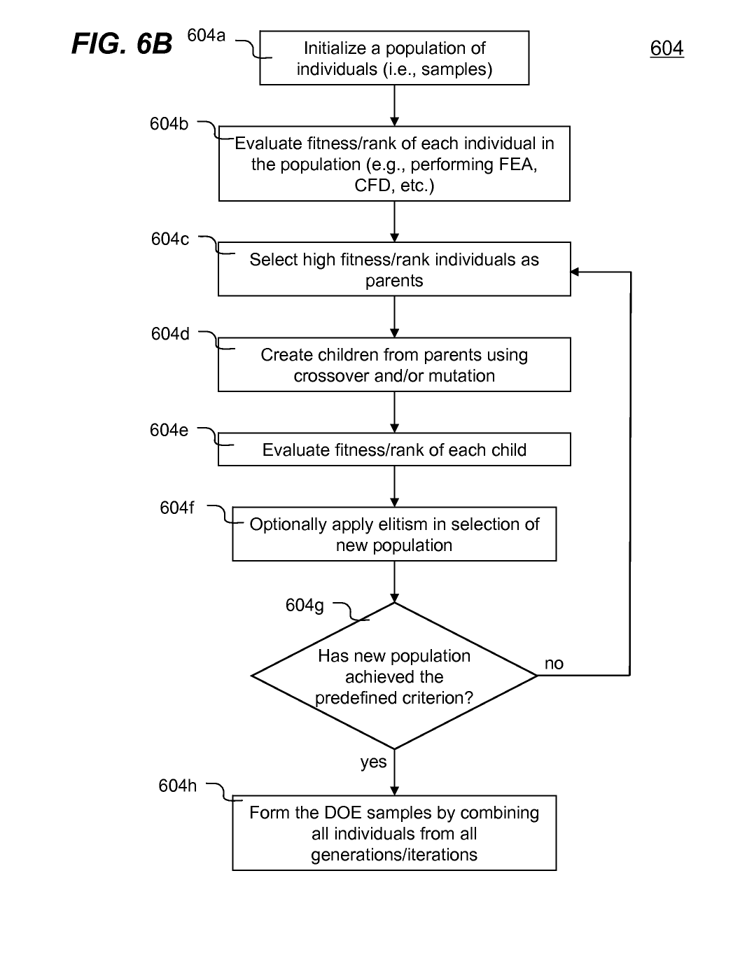

Referring now to FIGS. 6A-6B, which collectively are a flowchart illustrating an exemplary process 600 of performing engineering design optimization using genetic algorithm based sampling, according to an embodiment of the present invention. Process 600 may be implemented is software, hardware or a combination of both.

Process 600 starts by identifying a set of design variables, objectives and constraints of a product to be optimized at step 602. Next, at step 604, a number of design of experiments (DOE) samples are selected from a multi-dimensional design space defined by respective design variables. In step 604, genetic algorithms are used for creating the total samples. Detail process of the step 604 is described and shown in FIG. 6B below.

After the DOE samples are selected, a meta-model is constructed for approximating CAE analysis results of each CAE sample at step 608. The meta-model may be a response surface, a radial basis function based meta-model, etc. Next, a “best” product is obtained from an engineering optimization using the meta-model at step 614. At step 616, a CAE analysis of the “best” product is conducted. Finally, at decision 618, the CAE analysis results are compared to the approximated responses from the meta-model to determine whether the meta-model represents the actual design. If ‘no’, process 700 moves back to step 604 by choosing additional or different DOE samples to repeat the steps described herein until a satisfactory response has been reached. Otherwise the process 600 ends. In another embodiment, the process 600 may go back to step 608 to adjust the metal-model when the decision 608 is ‘no’.

Details of step 604 (selecting DOE samples using GA) are shown in FIG. 6B. At step 604a, a parent population of individuals (i.e., DOE samples) is initialized. For example, 100 individuals may be initialized for a total of 1000 samples to be created in 10 generations or iterations of GA. In other words, 100 individuals for each generation. The initial selection may be random or a predefined pattern/criterion. Next, at step 604b, each individual is assigned a fitness score or rank based on responses obtained in CAE analysis. At step 604c, high rank or fitness individuals in the parent population are preferably selected into a mating pool. Children population is then created from the parents in the mating pool using procedures such as crossover and/or mutation at step 604d. It is noted that either a binary or real number representation may be used. Also there are many parent/child patterns, for example, two parents for two children, three for four, two for one, etc. Both crossover and mutation processes are subject to a randomization procedure based on predefined probability. After the children population is created, each child is evaluated using CAE analysis and assigned a fitness or rank at step 604e. Next, an optional step 604f of applying elitism process is conducted. Elitism process may be performed in many ways, for example, combining all prior generation of populations and selecting a predefined number of individuals (again high rank or fitness individuals are preferred). Next, at decision 604g, it is determined whether a GA stopping criterion has been reached. The criterion may be fixed number of iterations or generations. Or, the criterion is to ensure there are no changes from prior generation to newly created generation (i.e., converged). If ‘no’, process 600 moves back to step 604b for creating another generation. Otherwise, process 600 follows the ‘yes’ branch to step 604h, in which DOE samples are formed. One of the methods to form DOE samples is to use all of the DOE samples created during GA selection process.

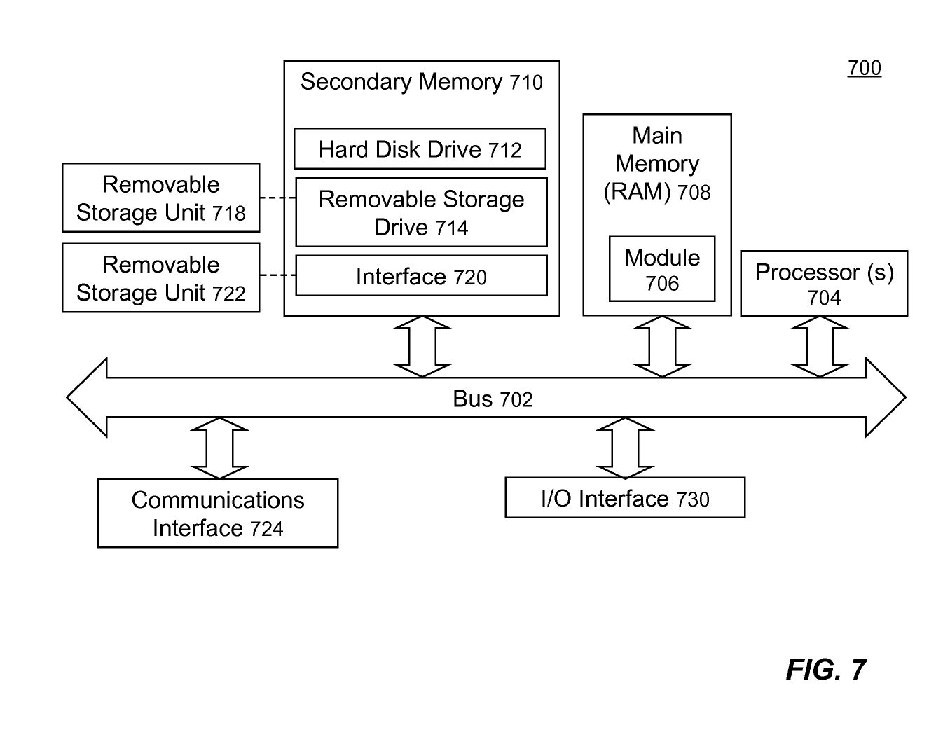

According to one aspect, the present invention is directed towards one or more computer systems capable of carrying out the functionality described herein. An example of a computer system 700 is shown in FIG. 7. The computer system 700 includes one or more processors, such as processor 704. The processor 704 is connected to a computer system internal communication bus 702. Various software embodiments are described in terms of this exemplary computer system. After reading this description, it will become apparent to a person skilled in the relevant art(s) how to implement the invention using other computer systems and/or computer architectures.

Computer system 700 also includes a main memory 708, preferably random access memory (RAM), and may also include a secondary memory 710. The secondary memory 710 may include, for example, one or more hard disk drives 712 and/or one or more removable storage drives 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 722 and interfaces 720 which allow software and data to be transferred from the removable storage unit 722 to computer system 700. In general, Computer system 700 is controlled and coordinated by operating system (OS) software, which performs tasks such as process scheduling, memory management, networking and I/O services. Exemplary OS includes Linux®, Microsoft Windows®.

There may also be a communications interface 724 connecting to the bus 702. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728 which may be electronic, electromagnetic, optical, or other signals capable of being received by communications interface 724. The computer 700 communicates with other computing devices over a data network based on a special set of rules (i.e., a protocol). One of the common protocols is TCP/IP (Transmission Control Protocol/Internet Protocol) commonly used in the Internet. In general, the communication interface 724 manages the assembling of a data file into smaller packets that are transmitted over the data network or reassembles received packets into the original data file. In addition, the communication interface 724 handles the address part of each packet so that it gets to the right destination or intercepts packets destined for the computer 700. In this document, the terms “computer program medium” and “computer usable medium” are used to generally refer to media such as removable storage drive 714, and/or a hard disk installed in hard disk drive 712. These computer program products are means for providing software to computer system 700. The invention is directed to such computer program products.

The computer system 700 may also include an input/output (I/O) interface 730, which provides the computer system 700 to access monitor, keyboard, mouse, printer, scanner, plotter, and alike.

Computer programs (also called computer control logic) are stored as application modules 706 in main memory 708 and/or secondary memory 710. Computer programs may also be received via communications interface 724. Such computer programs, when executed, enable the computer system 700 to perform the features of the present invention as discussed herein. In particular, the computer programs, when executed, enable the processor 704 to perform features of the present invention. Accordingly, such computer programs represent controllers of the computer system 700.

In an embodiment where the invention is implemented using software, the software may be stored in a computer program product and loaded into computer system 700 using removable storage drive 714, hard drive 712, or communications interface 724. The application module 706, when executed by the processor 704, causes the processor 704 to perform the functions of the invention as described herein.

The main memory 708 may be loaded with one or more application modules 706 that can be executed by one or more processors 704 with or without a user input through the I/O interface 730 to achieve desired tasks. In operation, when at least one processor 704 executes one of the application modules 706, the results are computed and stored in the secondary memory 710 (i.e., hard disk drive 712). The status of the CAE analysis or design optimization (e.g., samples selected based on GA) is reported to the user via the I/O interface 730 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas the number of design objectives and variables has been shown a two, in reality, a larger number of design objectives and variables have been used. Furthermore, whereas finite element analysis has been described and shown for stress analysis, other types of CAE analysis such as finite difference analysis or meshless analysis, etc. may be used to achieve the same. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of performing engineering design optimization of a product comprising:
specifying a set of design objectives and constraints, and a design space defined by at least one design variable;
selecting a plurality of design of experiments (DOE) samples based on genetic algorithms, wherein each of the DOE samples represents a unique design in the design space; and
deriving an optimal design of the product subject to the design objectives and constraints and based on responses obtained from a meta-model that is capable of approximating computer aided engineering (CAE) analysis responses of the selected DOE samples, wherein the optimal design is then verified by a CAE analysis.

2. The method of claim 1, wherein said selecting the plurality of DOE samples based on genetic algorithms further comprises:
(a) defining a parent population comprising a plurality of individual designs;
(b) performing CAE analysis of each of the individual designs in the parent population;
(c) assigning a fitness score or rank to said each of the individual designs based on results of the CAE analysis;
(d) selecting some of the individuals from the parent population as a plurality of mating parents according to the rank or fitness score;
(e) creating a child population from the mating parents in a new population producing scheme;
(f) performing CAE analysis of each of a plurality of individual designs in the child population;
(g) designating the child population as the parent population; and
(h) repeating (c)-(g) until a predefined stopping criterion has been met, then forming the DOE samples by choosing a set of unique individual designs that have been evaluated by the CAE analysis.

3. The method of claim 2, further comprises performing an elitism procedure before said designating the child population as the parent population step, the elitism procedure selects individual designs with higher rank or fitness score in a merged group containing the child population and the parent population.

4. The method of claim 2 wherein the fitness score or rank is determined using a non-domination criterion applied to all of the design objectives, and individual design having higher fitness score or rank is preferred to be selected as one of the mating parents.

5. The method of claim 2 wherein said each of the individual designs is represented a numerical means holding particular values of the at least one design variable embodied in said each of the individual designs.

6. The method of claim 5 wherein the numerical means comprises a sequence of binary numbers as genes of said each individual designs.

7. The method of claim 6 wherein the new population producing scheme comprises a crossover procedure, in which at least one gene between at least two of the mating parents is exchanged to create one of the individual designs in the child population based on a predefined crossover probability.

8. The method of claim 6 wherein the new population producing scheme comprises a mutation procedure, in which one or more genes of each of the individual designs in the child population is flipped based on a predefined mutation probability.

9. The method of claim 5 wherein the numerical means comprises a set of real numbers each represents one of the at least one design variable.

10. The method of claim 9 wherein a crossover procedure is conducted based on certain specific combination of relevant ones of the design variables.

11. The method of claim 10, wherein the predefined stopping criterion is based on total number of generations to be simulated in the genetic algorithms.

12. A system for performing engineering design optimization of a product comprising:
an input/output (I/O) interface;
a memory for storing computer readable code for an application module;
at least one processor coupled to the memory, said at least one processor executing the computer readable code in the memory to cause the application module to perform operations of:
specifying a set of design objectives and constraints, and a design space defined by at least one design variable;
selecting a plurality of design of experiments (DOE) samples based on genetic algorithms, wherein each of the DOE samples represents a unique design in the design space; and
deriving an optimal design of the product subject to the design objectives and constraints and based on responses obtained from a meta-model that is capable of approximating computer aided engineering (CAE) analysis responses of the selected DOE samples, wherein the optimal design is then verified by a CAE analysis.

13. The system of claim 12, wherein said operations of selecting a plurality of DOE samples based on genetic algorithms further comprises:
(a) defining a parent population comprising a plurality of individual designs;
(b) performing CAE analysis of each of the individual designs in the parent population;
(c) assigning a fitness score or rank to said each of the individual designs based on results of the CAE analysis;
(d) selecting some of the individuals from the parent population as a plurality of mating parents according to the rank or fitness score;
(e) creating a child population from the mating parents in a new population producing scheme;
(f) performing CAE analysis of each of a plurality of individual designs in the child population;
(g) designating the child population as the parent population; and
(h) repeating (c)-(g) until a predefined stopping criterion has been met, then forming the DOE samples by choosing a set of unique individual designs that have been evaluated by the CAE analysis.

14. The system of claim 13, further comprises operation of performing an elitism procedure before said designating the child population as the parent population step, the elitism procedure selects individual designs with higher rank or fitness score in a merged group containing the child population and the parent population.

15. The system of claim 13 wherein the fitness score or rank is determined using a non-domination criterion applied to all of the design objectives, and individual design having higher fitness score or rank is preferred to be selected as one of the mating parents.

16. The system of claim 13 wherein said each of the individual designs is represented a numerical means holding particular values of the at least one design variable embodied in said each of the individual designs.

17. A computer usable medium having computer a readable medium stored thereon to perform a method of performing engineering design optimization of a product comprising:
computer readable code for specifying a set of design objectives and constraints, and a design space defined by at least one design variable;
computer readable code for selecting a plurality of design of experiments (DOE) samples based on genetic algorithms, wherein each of the DOE samples represents a unique design in the design space; and
computer readable code for deriving an optimal design of the product subject to the design objectives and constraints and based on responses obtained from a meta-model that is capable of approximating computer aided engineering (CAE) analysis responses of the selected DOE samples, wherein the optimal design is then verified by a CAE analysis.

18. The computer usable medium of claim 17, the computer readable code for selecting a plurality of DOE samples based on genetic algorithms further comprises computer readable code for:
(a) defining a parent population comprising a plurality of individual designs;
(b) performing CAE analysis of each of the individual designs in the parent population;
(c) assigning a fitness score or rank to said each of the individual designs based on results of the CAE analysis;
(d) selecting some of the individuals from the parent population as a plurality of mating parents according to the rank or fitness score;
(e) creating a child population from the mating parents in a new population producing scheme;
(f) performing CAE analysis of each of a plurality of individual designs in the child population;
(g) designating the child population as the parent population; and
(h) repeating (c)-(g) until a predefined stopping criterion has been met, then forming the DOE samples by choosing a set of unique individual designs that have been evaluated by the CAE analysis.

19. The computer usable medium of claim 18 further comprises computer readable code for performing an elitism procedure before said designating the child population as the parent population step, the elitism procedure selects individual designs with higher rank or fitness score in a merged group containing the child population and the parent population.

20. The computer usable medium of claim 18, wherein the fitness score or rank is determined using a non-domination criterion applied to all of the design objectives, and individual design having higher fitness score or rank is preferred to be selected as one of the mating parents.
